(19) United States
(12) Patent Application Publication
(10) Pub. No.: US 2005/0053524 A1
(43) Pub. Date: Mar. 10, 2005

(54) Molecularly controlled dual gated field effect transistor for sensing applications

(76) Inventors: Koen De Keersmaecker, Herent (BE); Gustaaf Borghs, Leuven (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/403,807

(22) Filed: Mar. 27, 2003

Related U.S. Application Data
(60) Provisional application No. 60/369,051, filed on Mar. 28, 2002.

(30) Foreign Application Priority Data
Mar. 29, 2002 (EP) 02447050.2

(51) Int. Cl. G01N 27/00

(52) U.S. Cl. 422/88; 422/98

(57) ABSTRACT

A sensing device and method of making and using the sensing device. The device comprises a sensing gate layer of multifunctional organic sensing molecules having at least one functional group that binds to the semiconductor layer and at least another functional group that serves as a sensor. The device further comprises a semiconductor channel layer, a drain electrode, a source electrode, and a biasing gate. The source and drain electrodes and biasing gate are situated on the same side of the device and simultaneously on the opposite side of the sensing gate layer. The sensing gate layer may be directly in contact with the intermediate layer or the semiconductor channel layer.

### RELATED APPLICATIONS

This application claims priority to, and hereby incorporates by reference in its entirety, co-pending U.S. Provisional Application No. 60/369,051 entitled “MOLECULARLY CONTROLLED DUAL GATE FIELD EFFECT TRANSISTOR FOR SENSING APPLICATIONS”, which was filed on Mar. 28, 2002. This application further claims priority to, and hereby incorporates by reference in its entirety, co-pending European Patent Application No. 02447050.2, which was filed on Mar. 29, 2002.

### FIELD OF THE INVENTION

The present invention relates to the field of semiconductor devices and more particularly to hybrid organic/inorganic sensors used for the direct sensing upon double gate transistors.

### DESCRIPTION OF THE RELATED ART

A sensor is a device used to detect ions, molecules or energies of any kind. Its sensitivity and its selectivity as well as the lifetime determine the quality of a sensor.

The combination of semiconductors with organic molecules is an attractive option for sensors. This combination offers the advantage to associate sensitivity and selectivity through a molecular detection layer.

A mere change in electron density or electronegativity of the molecular surface-adsorbate complex, upon physical or chemical perturbation, results in a direct and fast change of electro-optical properties of the semiconductor sensor. In consideration to their direct and fast transduction principle, hybrid organic/inorganic sensors allow real-time monitoring of dynamic processes with unparalleled sensitivity.

The realisation of hybrid organic/inorganic III-V semiconductors for sensor applications requires that key issues such as selectivity, sensitivity, kinetics, long term stability and reproducibility, are addressed by the appropriate surface chemistry.

Sensors based on field effect transistors exhibit a third electrode (gate) located between the two main current-carrying contacts (source and drain). The gate is used to control the current through the device. U.S. Pat. No. 4,777,019, entitled “BIOSENSOR”, which is hereby incorporated by reference in its entirety, discloses such a device where the sensor effect is based on changing the current passing through the device due to the absorption of molecules on the gate. ISFET sensors are also disclosed in German Patent Publication No. DE4316086, filed Nov. 17, 1994, and PCT Publication WO94/22006 A1, entitled “SEMICONDUCTOR COMPONENT, PARTICULARLY FOR ION DETECTION”, which are hereby incorporated by reference in their entirety.

U.S. Pat. No. 3,831,432 entitled “ENVIRONMENT MONITORING DEVICE AND SYSTEM”, which is hereby incorporated by reference in its entirety, describes an ungated field-effect transistor (FET) using an adsorption layer between the source and drain with two spaced apart regions of opposite conductivity type. These ungated devices are oversensitive to electrical interferences, which leads to unwanted high noise levels compared to gated devices.

ISFETs are field effect devices in which an adsorbed molecule such as an ion changes the current between source and drain. ISFETs may also be used for sensing “neutral” molecules upon the use of a catalytic intermediate layer that transforms the analyte into a loaded species that may be adsorbed onto the gate area/dielectric and modulate the current through its field effect.

Document PCT Publication No. WO 98/19151, entitled “HYBRID ORGANIC-INORGANIC SEMICONDUCTOR STRUCTURES AND SENSORS BASED THEREON”, which is hereby incorporated by reference in its entirety, discloses a hybrid organic/inorganic transistor as a sensor for chemicals and light comprising a semiconductor layer, an insulation layer and a thin active layer of multifunctional organic sensing molecules directly chemisorbed between the source and drain electrical contacts. This configuration presents the disadvantage of a static use requiring an adaptation of the thickness for each type detection. For such a sensor the active detection area is reduced in practice and the electronic part is easier exposed to the analyte substract. As far as micro-electronics and liquids are incompatible, the micro-electronics have to be insulated as much as possible from the liquid environment to avoid corrosion problems.

The document Perkins, et al., “An active microelectronic transducer for enabling label-free miniaturized chemical sensors”, International Electron Devices Meeting. Technical Digest. IEDM, 10-13, (Dec. 2000), describes a depletion mode transducer based on silicon ISFET technology with an organic sensing layer adsorbed on the gate area. This device resembles standard ISFETs in that it is a gateless three-electrode field effect transistor.

However, being a depletion mode device, it lacks the necessity of actively biasing the transistor into conduction. This is achieved by implanting a suitable dose of load carriers. Again, this is a static way of biasing a transistor which has to be adapted during its production according to the type of organic sensing layer and which is simultaneously done at wafer level for all sensor elements. As for standard ISFETs, the device is sensitive to loads that are adsorbed on the gate area. Furthermore, when used as described in Perkins, the device becomes sensitive to neutral molecules since their adsorption on the organic sensing layer changes the capacitive coupling of the voltage of the electrolyte solution to the channel, resulting in a mere linear change of the source-drain current. However, this set-up requires an electrolyte solution to be present on the top of the gate area. The consequence is a lower sensitivity due to the inherent native oxide of silicon which implies tight specifications for packaging due to current carrying electrodes at the solution side of the device.

### SUMMARY OF THE INVENTION

The present invention aims to provide a sensor based on a direct sensing mechanism with a high sensitivity, a large detection area without passivating native oxide layer and with direct contact between the sensing gate layer and the semiconductor channel layer and a method for the production of said device.

In one embodiment, the invention provides a sensing device comprising an organic sensing layer comprising at least one functional group, and further comprising at least another functional group configured to serve as a sensor. The sensing device further comprises a semiconductor layer comprising a first side and a second side, wherein the functional group is operatively associated with the semiconductor layer. The sensor device further comprises a drain electrode electrically connected to the semiconductor layer, and a source electrode electrically connected to the semiconductor layer. The sensor device further comprises a gate electrode electrically connected to the semiconductor layer. The source electrode, drain electrode and gate electrode are positioned on the first side of said semiconductor layer, and the sensing layer is positioned on the second side of said semiconductor layer.

In another embodiment, the invention provides a method of producing a sensing device comprising forming an organic sensing layer and forming a semiconductor channel layer having a first surface that is situated substantially in contact with the sensing layer. The method further comprises positioning a drain electrode on a second surface of the semiconductor layer, and positioning a source electrode on the second surface of the semiconductor layer. The method further comprises positioning a biasing gate on the second surface of the semiconductor layer.

### BRIEF DESCRIPTION OF THE DRAWINGS

FIG. 1 shows a dual gate transistor showing the first embodiment of the present invention comprising no intermediate layer 2.

FIG. 2 shows a dual gate transistor showing the second embodiment of the present invention with an intermediate layer 2 to cushion the signal produced by the analyte.

### DETAILED DESCRIPTION OF THE INVENTION

The present invention discloses a sensing device comprising an organic sensing layer (1) having at least one functional group that binds to the semiconductor layer (3) and at least another functional group that serves as a sensor, a semiconductor layer (3) having a first side and a second side, a drain electrode (6), a source electrode (5), a gate electrode (4), wherein said source electrode (5), said drain electrode (6) and said gate electrode (4) are situated on the first side of said semiconductor layer and that said sensing layer (1) is situated on the second side of said semiconductor layer and that said sensing gate layer (1) is operatively associated with the semiconductor layer and that said semiconductor layer has a thickness below 5000 nm.

Said sensing device converts a non-electrical signal into an electrical signal. A non-electrical signal may be generated by a physical or a chemical event. The physical or chemical event may be, but is not limited hereto, a change of temperature, pressure, the presence of molecules or electrolytes, or radiation.

Operatively associated means that any change in the sensing layer results in a change of the optoelectronic properties of the semiconductor layer. Said sensing layer may act as a second gate electrode. The dynamic influence of surface states between the sensing layer and the underlying layer may also be detected, i.e. trapping of load which has an influence not only on direct current (DC) characteristics of the transistor but also on the alternating current (AC) characteristics, optical properties and e.g., decay of photocurrent. In a particular embodiment, said sensing layer is in direct contact with said semiconductor layer.

Said sensing layer is situated on the first side of the semiconductor layer. Since the source electrode, the drain electrode and the gate electrode are situated on the second side of the semiconductor layer, the packaging of the sensing device is facilitated.

The semiconductor layer is chosen so as it may act as a current path between source and drain electrode. The electrical field in the channel of the device is modified by a change in the sensing layer, or a change of the rate of charge transfer between the sensing layer and the underlying layer (dynamic influence of the surface state).

The detection principle is further based on the interaction of electron orbitals of the absorbed molecules and the semiconductor material. This interaction generates a modulation of the surface potential upon change in electronegativity of the absorbate-surface complex or modulation of surface potential by voltage on the sensing layer. This is also called the field-effect operation of the device, mostly DC oriented.

However, the device may also detect changes in the coupling between the sensing layer (or the intermediate layer) and the bulk semiconductor (e.g., decay of photocurrent or spectroscopic AC measurements).

The semiconductor layer may be a doped/undoped semiconductor material. Non-restrictive examples of such materials are silicon, germanium, III-V or II-VI materials or semiconductor polymeric materials. III-V materials may be materials selected from the group consisting of Al, Ga, In, Ti, P, As, Sb, Bi or combinations thereof. II-VI materials may be materials selected from the group consisting of Zn, Cd, Hg, Se, Te, Po or combinations thereof. A combination of materials from group III-V and group II-IV is also included.

In the semiconductor material, a conducting channel is created upon modulation by the source electrode 5 or the gate electrode 6. The semiconductor layer 3 only comprises the active part of FET device.

The thickness of the semiconductor layer may be preferably below 5000 nm, more preferably below 1000 nm, and most preferably below 500 nm. The thickness of a MESFET is 100-500 nm depending on the doping concentration of the channel layer. However, in HEMTs, the semiconductor layer may be below 300 nm, more preferably below 200 nm, and most preferably below 100 nm. Compared to semiconductor layer with a thickness over 5000 nm, the device as disclosed in this invention ensures the generation of the field-effect by the sensing layer, preferably by applying voltages on the gate electrode lower than 10 V. This is a main advantage compared to the prior art, where the thickness of the semiconductor layer is over 5000 nm, which requires higher voltages on the gate electrode in order to generate a field-effect by the sensing layer.

However, high voltages may damage the organic or inorganic layers (breakdown), or may start catalysing the electrolyte solution. Thus, applying high voltages does not allow the use of the device in a liquid medium and may destroy the sensing layer.

Said sensing gate layer is chosen so as to ensure the field-effect generation and thus the current flowing in the transistor channel or to ensure the change in coupling between the sensing layer and the semiconductor layer. Said sensing layer may be chosen so as to have a certain sensitivity towards the chemical molecules to be detected.

Said sensing layer may be a layer comprising organic molecules. Said organic molecule comprises at least a functional group attached to the surface and a functional group that serves as sensor. As used herein, attached to the surface refers to formation of a bond between the surface and the functional group selected from the group comprising a coordinative bond, a covalent bond, chemisorption, ionic bond, partially ionic bond and the like. Said functional group that serves as sensor may be understand as an functional group being adapted to undergo a change due to a non-electrical signal or being bound to recognition compound being able to undergo a change due to a non-electrical signal.

Said sensing layer may have a thickness below 100 nm, below 50 nm, below 30 nm, below 20 nm, below 10 nm.

Said sensing layer could comprise at least a self-assembling monolayer, a polymeric layer or a langmuir blodget film, but is not limited hereto.

In a preferred embodiment, said organic sensing layer is a self-assembling monolayer. Self-assembled monolayers (SAM) may be understood as a relatively ordered assembly of molecules that spontaneously adsorb (also called chemisorb) from either the vapour or liquid phases on a surface. The self-assembly is driven by preferential bond formation of an appropriately functionalised group onto specific substrate surface sites. A self-assembling molecule comprises at least a functional group attaching to the bonding surface, a spacer group and a terminal group. The functional group attaching to the bonding surface may vary, depending on the material characteristics of the bonding surface material, e.g., thiols on metals. The functional group attaching to the surface may comprise S, Si, carboxylic acids, sulfonates (SO₃—) and phosphonates (PO₃—). Lateral interactions between the spacer segments, such as but not limited hereto, hydrocarbon segments of the molecules, comprising alkaline chains and/or aromatic groups. Said terminal end-group serves as sensor. The molecules are preferably oriented perpendicular with respect to the substrate surface plane with all trans extended hydrocarbon chains oriented close to the surface normal.

Said sensing layer may comprise a self-assembling monolayers or mixed self-assembling monolayers with adequate chemical functions. Non-restrictive examples of such functions are silanes, thiols, carboxylic acids, sulfonates (SO₃—) and phosphonates (PO₃).

Furthermore, the sensing gate layer 1 may comprise subsequently applied multiple layers with or without chemical reactive interlayer.

In another embodiment, said sensing layer may also be an inorganic layer such as SiO₂, Ta₂O₅, and others. Furthermore, said sensing layer may be a metallic layer.

Said sensing layer may be selected such that it undergoes or induces a change (due to a non-electrical signal) in:
the workfunction of the semiconductor material at the surface or
the workfunction of the sensing layer or
surface potential of the semiconductor material
   Either of these changes may be induced, but do not necessarily have to be induced by changes in dipole moment (permanent or induced), introduction of charges in the sensing layer, redistribution of charges in the sensing layer or a change in the surface recombination velocity at the semiconductor surface.

The backside source 5 and drain 6 electrodes ensure an ohmic contact to the semiconductor layer 3. The gate electrode 4 allows biasing the current flowing between source and drain, depending on the specific application, independently of the structure of the semiconductor layer or of the type of molecules constituting the organic sensing layer, and of an individual sensor element if multiple sensors are in the same liquid: multiple ISFETs may only be biased via the liquid, which implies that all sensor elements of an array have to be simultaneously biased. The organic sensing layer in itself (without analyte bonded) already has a strong influence on the opto-electronic properties of the semiconductor, and thereby has to be taken into account when designing a hybrid sensor.

This means that the sensitivity of the device may be determined by the voltage applied to the gate 4 electrode. This is an advantage compared to prior art devices, where the sensitivity may not be tuned by the biasing voltage but for example by adjusting the thickness of the semiconductor layer or the doping of the semiconductor layer since both are static.

The source electrode, the drain electrode and the gate electrode may be made of organic containing material or may be made of metals such as, but not limited to, gold, gold-germanium, aluminum or platinum. The biasing gate allows variable individual biasing of the FET to mitigate processing deficiencies or create optimum working conditions according to the type of molecules used on the sensing gate.

On III-V and II-VI semiconductor, Schottky gate contacts are usually created: an appropriately chosen metal structure in direct contact with the semiconductor creates an energy barrier which may allow the gate to bias the surface potential. In this case, there is no need for a dielectric layer. On silicon and polymers semiconductors, a high k (because of its electrical permittivity) dielectric is first deposited, in the past silicondioxide isolator was used but now even tantalumoxides or more exotic compounds are found. It will serve as the gate-oxide to ensure a good capacitive coupling of the gate electrode with the channel in the semiconductor layer.

New developments aim to create such a high-quality dielectric on top of III-V materials. In the future, this 7^{th} layer may be available on all semiconductor devices, independently of the type of semiconductor underneath.

Said device may further comprise an intermediate layer between the sensing layer and the semiconductor layer. Said intermediate layer is preferably a crystalline material that allows a direct contact with the organic sensing layer. Cristallinity allows that the interaction of molecular orbitals with the semiconductor bulk is maximised.

Said intermediate layer may be a layer allowing a better deposition of the sensing layer. Said intermediate layer may also be a layer accounting for reducing the sensitivity of the device in order to avoid a high noise signal.

The intermediate layer may comprise a dielectric material, such as an inorganic oxide, e.g., SiO₂, or inorganic (oxy)nitride, such as Si₃N₄, or another amorphous metallic material selected from the group comprising TiO₂, Ta₂O₅, BaTiO₃, BaₓSr₁₋ₓTiO₃, Pb(ZrₓTi₁₋ₓ)O₃, SrTiO₃, BaZrO₃, PbTiO₃, LiTaO₃. The dielectric material may also comprise a polymer, such as SU-8 or BCB.

The intermediate layer may comprise a crystalline layer, comprising materials selected from the group consisting of Ga, As, N, P, In, Al and compounds thereof. An example of such a crystalline intermediate layer is low-temperature grown GaAs which presents a lower tendency to oxidise, may be made semi-insulating, thereby constituting a dielectric material, and has a high dielectric constant. If the intermediate layer is amorphous, molecular-bulk orbital mixing is reduced, thereby reducing the sensitivity of the device.

Preferably, the dielectric constant of the dielectric material may be as high as possible, preferably above 3, above 5, above 10, above 15 above 20 or above 30.

The thickness of the intermediate layer is determined by the compromise of sufficient protection and high capacitive coupling, and could be between 10 nm and 500 nm, between 10 nm and 300 nm, between 10 nm and 200 nm. Between 50 nm and 200 nm and preferably be between 50-100 nm. The intermediate layer may be deposited after flip-mounting the FET structure, as in the case of standard amorphous dielectric material, or it may be created during the production (e.g., molecular beam epitaxial growth) of the semiconductor channel layer, as in the case of low-temperature grown GaAs for example.

Material constraints are dictated by the fact that all parts wetted during normal operation of the sensor, may withstand corrosion by the liquid medium.

For instance, biomolecules, mainly proteins, and some functional molecules limit the maximum process temperature since they tend to denature and/or loose their function when the temperature is raised too much. On the other hand, standard flip chip bonding involves temperatures as high as 350° C. to reflow the solder bumps.

Patterning of organic layers may be readily done using UV-lithography techniques (masking or cleavage) but this technique may be done at wafer-level, before dicing and packaging.

If, due to the raised temperatures during standard packaging, we decide to shift surface modifications with bio or functional molecules back in the process flow, patterning has to be done at chip-level. In that case, only the less accurate micro-contact printing or dispensing techniques are viable options for patterning the organic layers.

Finally, a lot of semiconductor materials have a limited temperature budget: they may withstand a certain temperature only for a limited time before electronic properties start to degrade (e.g., because of diffusion). Hence, not only maximum temperature but also the time required for chemical synthesis may become a critical parameter.

The current invention relaxes the packaging specifications in liquid environments. The sensor envisioned in the current invention is flipped with its current/voltage carrying electrodes (source, drain and biasing gate) facing the host substrate. Since the live electrodes are situated on the opposite side of the semiconductor layer, away from the side that would get into contact with liquids, the current invention facilitates packaging compared to conventional sensors.

Conventional sensors, as mentioned in the background and state of the art, all have their current/voltage carrying electrodes at the front side facing the liquid. This conventional approach requires exact alignment of a sealing agent to shield these electrodes and at the same time leave the sensing area exposed. Defects in the sealing agents of conventional devices are prone to a higher chance of having detrimental results. The current invention mitigates these problems by putting its live electrodes at the backside.

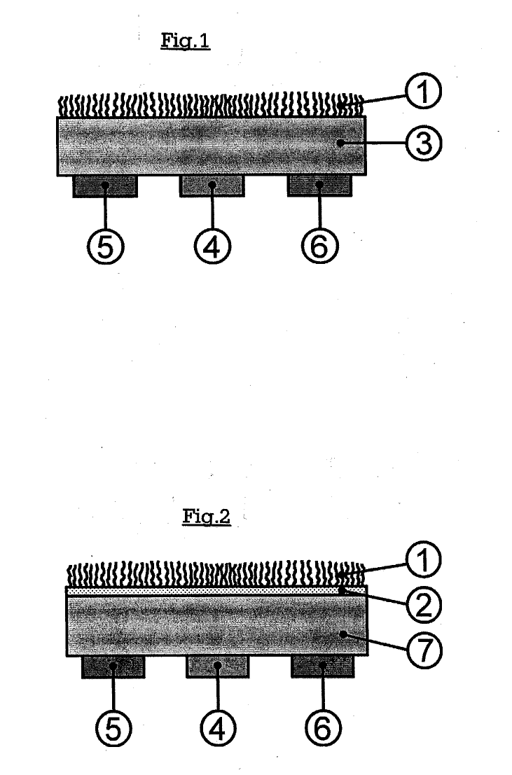

As noted above, a sensing device is disclosed as illustrated in FIG. 1. The signal created by the presence of an analyte on the sensing layer is transmitted to the semiconductor channel layer 3 without any cushioning effect. The second embodiment of the present invention is illustrated in FIG. 2, where an intermediate layer 2 is present between the sensing layer 1 and the semiconductor channel layer 3.

In reference to FIG. 1, a preferred embodiment of the present invention comprises a semiconductor channel layer (3). This layer provides current flow susceptible to a field effect or has opto-electronic characteristics that may be modulated by molecular adsorption. Depending on the type of field effect transistor that will be used as the micro-electronic transducer, the structure of the semiconductor channel layer (3) will differ.

If the transducer is a MESFET type, the semiconductor layer (3) comprises a highly n⁺-doped GaAs layer on top of a lower n-doped GaAs layer, both doped with for example Si. The top layer has a doping concentration of a few times 10¹⁸ cm⁻³, while the lower doped layer has a doping between a few times 10¹⁶ cm⁻³ up to a few times 10¹⁷ cm⁻³, preferably about 10¹⁷ cm⁻³. For a doping concentration of 10¹⁷ cm⁻³, the lower doped layer is about 200 to 300 nm thick.

The source (5) and drain (6) contacts provide an ohmic contact to the semiconductor channel layer (3) through the proper metal stacks, such as Au/Ni/Au₈₈Ge₁₂:n⁺-GaAs. A Schottky gate contact (4) is created by an appropriate metal stack, such as Au/Pt/Ti:n-GaAs, that ensures a high potential barrier between the metal and the semiconductor channel layer.
The organic sensing layer (1) may provide at least some but not necessarily all of the following functions:
a) an intimate and stable binding to the surface of the semiconductor channel layer (3) or to the intermediate layer (2) to assure long-term stability and optimal molecular-surface state orbital mixing,
b) adequate passivation and protection of the surface,
c) a tailored influence on the electro-optical properties of the semiconductor channel layer underneath,
d) an immobilised molecular sensing function, and
e) molecular function to prevent non-specific adsorption to reduce noise from adsorbing non-targeted analytes.

The multifunctional organic sensing layer (1) comprises a surface anchoring functional group that preferably binds the organic sensing layer covalently/coordinatively to the semiconductor channel layer (3) from the side opposite the said source (5), drain (6) and gate (4) electrodes. The surface anchoring functional group may be chosen to be e.g., a thiol, a disulfide, a carboxylic acid, a sulfonate or a phosphonate.

Furthermore the organic sensing layer comprises an immobilised molecular sensor function, sensitive to light or electrical fields for example, such as, but not limited to, 4-[4-N,N-bis(hydroxylethyl)aminophenylazo] pyridinium, sensitive to biomolecules/proteins for example, such as single DNA strands or antibodies, or sensitive to ions or chemical agents for example.

Every single analyte requires a different selectively.

The intermediate layer (2) may have many functions. It may be introduced to cushion the signal, i.e. to reduce the sensitivity of the device. The intermediate layer (2) might be needed to protect the semiconductor channel layer (3) from degradation, e.g., in wet operating conditions due to electrochemical reactions or for example the oxidation of organic semiconductor polymers. Alternatively, the intermediate layer (2) may help to create a surface more susceptible to an appropriate type of surface chemistry treatment. Depending on its intended function, the characteristics and materials of the intermediate layer may be adapted.

The sensor operation is statically biased during production by the semiconductor layer (3) characteristics, such as the layer structure, the doping concentration and the thickness, and by the overall influence of the organic sensing layer. In the latter regard, the choice of a specific binding group or the inclusion of functional groups to tune the opto-electronic characteristics of the semiconductor channel underneath play an important role. During operation the sensor may be biased by the gate electrode (4).

Furthermore, an array of sensors is disclosed. Said array comprises at least 2 sensors. Said sensors are the sensors disclosed in this application.

The production of the sensor according to the present invention may be described in several steps:
In a first step, a micro-electronic field-effect transistor (FET) is created on a sacrificial substrate by using processing steps known in integrated circuit manufacturing.
In a second step, a single FET is obtained by dicing the wafer. This single FET is flipped and mounted upside down on a host-substrate, using a glue layer, such as BCB. This procedure may be executed on bars or even an entire wafer of FETs.
In a third step, the primary substrate is thinned down by using techniques such as chemical mechanical polishing, dry and wet etching. When desired, the sacrificial substrate may be completely removed using wet and/or dry etching techniques, leaving only the semiconductor channel layer (3) with or without an intermediate layer (2).
In a fourth step, the active area of the FET is protected for example by a photolithographically definable polymer, and the source (5), drain (6) and gate (4) electrodes are partially exposed using wet or dry etching techniques. Subsequently, electrical connections are created on the host-substrate, contacting the FET electrodes.
Subsequent processing involves, but not necessarily in this order, dicing of the host-substrate, packaging of the die and application and possibly patterning of the organic sensing layer. The exact scheduling of these process steps depends on the nature of the organic sensing layer and the materials used for packaging and for the production of the transducer. A possible process flow would be to attach at the wafer-level of the host-substrate a first patterned organic layer, a so-called anchoring layer, on the second side of the transducers. The host-substrate is then diced, singulating sensor chips, which are then packaged. Finally, the remainder of the organic sensing layer is applied.
For the application of an organic sensing layer, many strategies are possible, but mainly two of them are applied. In a first approach, a multifunctional molecule comprising all desired functions is grafted to a reactive surface in a one-step reaction. A second method involves the synthesis of the required organic architecture by in-situ chemistry on the surface: new layers are consecutively grafted from the previously attached layer. A compromise has to be made between a minimal number of reaction steps (to ensure a high overall reaction yield) and a well-controlled coverage of the anchoring layer (i.e. the first layer, which has a strong effect on the electronic passivation of the surface). Preferably, a two-step approach is used.

Disclosed hereafter is a preferred embodiment to create an organic sensing layer. From liquid or vapour phase, a self-assembled monolayer (SAM) or self-assembled mixed monolayer is formed on the surface of the semiconductor channel layer (3) or of the intermediate layer (2). This first layer comprises anchoring molecules with basically three functions: a binding group, a spacer and a functional endgroup. Covalently binding molecules are preferred to ensure long-term stability. The spacer properties strongly affect the kinetics of the self-assembly process and the interlayer stacking of the resulting SAM. The functional endgroup may tune hydrophobicity of the SAM to control non-specific adsorption or may provide a reactive group so that the anchoring SAM constitutes a precursor for the subsequent organic layer. Mixed SAMs of anchoring molecules with different functional endgroups and/or spacers may be used to tailor the surface characteristics to various needs (e.g., prevent non-specific adsorption while still providing sufficient immobilisation sites for the subsequent layer).

A second monolayer may be grafted from the anchoring SAM by in-situ chemistry or physisorption from liquid or vapour (e.g., molecular layer epitaxy) phase. Next to a lower binding and an upper reactive linker group, the reagent may comprise auxiliary functional groups that allow control over molecular dipole moments and/or frontier orbital energy levels. Hence, this second layer simultaneously may offer immobilisation sites for the subsequent layers (e.g., molecular sensing function) and may fine-tune the opto-electronic properties of the semiconductor channel layer (3) underneath.

Patterned application of the organic sensing layer (1) may be achieved by means of e.g., lithographic masking techniques, deep UV photo-cleavage, micro-contact printing, dispensing techniques, and other similar means.

The sensor as disclosed may be used to detect, measure and monitor the physicochemical properties of a sample. A sample may be a solid, a solution, a gas, a vapour or a mixture of these. The physicochemical properties are determined by the presence in the sample of an analyte.

An analyte may for example be an electrolyte, a biomolecule, a neutral molecule, a change in pressure, and a change in temperature and radiation.

Depending on the measurement method, the sensor as described may be used with a reference electrode or a reference sensor, or a combination of both. The sensor may be used with a reference sensor for example as part of a differential amplifier circuit in which one of the inputs is a reference sensor, and the sensor constitutes the other input. In a liquid environment, the sensor may be used with or without reference electrode.

Several measurement methods may be thought of, therefore the following enumeration is non-exhaustive. Due to its specific nature, the sensor as disclosed may be biased via the gate electrode (4) or via biasing the sample (e.g., by the use of a reference electrode in an aqueous environment) in contact with the organic sensing layer (1) to modulate the current between source (5) and drain (6) electrode, or to modulate the opto-electronic properties of the semiconductor channel layer (3).

The sensor is preferably biased via the gate electrode (4). In the fixed gate voltage mode, the gate electrode (4) or the sample is kept at a fixed voltage with respect to the sensor source electrode (5), and the current flowing between source (5) and drain electrodes (6) is recorded in function of the changes in the sample. A possible application of the measurement method is to monitor the effect of a change in the physicochemical nature of the sensing layer on the opto-electronic properties of the semiconductor channel layer on a time-resolved scale. For instance, the decay of the photocurrent between source and drain after pulsed illumination of a light sensitive sensing layer may be measured while the source drain voltage is kept constant.

In constant drain current mode, the current between source and drain is kept constant by adjusting the voltage drop between the gate electrode (4) or the sample and the source. The response of the sensor is the variation of the voltage drop in function of changes in the sample.

The bias applied to the gate electrode (4) may be also a known AC modulated voltage. If this AC modulated voltage has a constant frequency, the sensor as disclosed may be used as a mixing element in which the signal from the sensing layer (1) will be mixed with the known AC modulated bias. For instance, this measurement method might prove useful to reduce noise or to look the mixing of radiation with the known AC modulated bias. If the frequency of the AC modulated bias is made variable, the device may be used to make spectroscopic measurements of the changes in the opto-electronic properties of the semiconductor channel layer in function of changes in the sample, interacting with the device via the sensing layer.

1. A sensing device comprising:
an organic sensing layer comprising at least one functional group, and further comprising at least another functional group configured to serve as a sensor;
a semiconductor layer comprising a first side and a second side, wherein the functional group is operatively associated with the semiconductor layer;
a drain electrode electrically connected to the semiconductor layer;
a source electrode electrically connected to the semiconductor layer; and
a gate electrode electrically connected to the semiconductor layer, wherein said source electrode, said drain electrode and said gate electrode are positioned on the first side of said semiconductor layer, and wherein said sensing layer is positioned on the second side of said semiconductor layer.

2. The sensing device of claim 1, wherein said sensing gate layer is operatively associated with the semiconductor layer and that said semiconductor layer has a thickness below 5000 nm.

3. The sensing device of claim 1, further comprising an intermediate layer situated between the sensing layer and the semiconductor layer.

4. The device of claim 1, wherein said organic sensing layer has a thickness below 100 nm.

5. The device of claim 1, wherein said sensing layer comprises a self-assembling monolayer.

6. The sensing device of claim 1, wherein the material of the semiconductor channel layer comprises a material selected from the group consisting of Silicon, Germanium, Gallium, Arsenic, Indium, Aluminium, Phosphor and compounds thereof.

7. The sensing device of claim 1, wherein said intermediate layer comprises a crystalline layer.

8. The sensing device of claim 3, wherein the material of the intermediate layer (2) comprises material selected from the group consisting of Ga, As, N, P, In, and Al.

9. The sensing device of claim 3, wherein the intermediate layer has a thickness between 10 nm and 400 nm.

10. A method of producing a sensing device comprising:
forming an organic sensing layer;
forming a semiconductor channel layer having a first surface that is situated substantially in contact with the sensing layer;
positioning a drain electrode on a second surface of the semiconductor layer;
positioning a source electrode on the second surface of the semiconductor layer; and
positioning a biasing gate on the second surface of the semiconductor layer.

11. The method of claim 10, further comprising forming an intermediate layer comprising a semiconductor, wherein said sensing layer is operatively associated with the intermediate layer.

12. The method of claim 11, wherein the intermediate layer is introduced between the sensing layer and the semiconductor layer.

13. The method of claim 10, wherein the sensing gate is formed by a self-assembling monolayer or a mixed self-assembling monolayer comprising functionalized molecules.

14. The method of claim 10, wherein the semiconductor layer is formed to a thickness between 10 and 5000 nm.

15. The method of claim 10, further comprising using the sensing device in the detection of chemicals.

16. The method of claim 10, further comprising using the sensing device in the detection of energy.

17. The method of claim 10, wherein the sensing layer is formed with a thickness of at most 100 nm.

18. The method of claim 10, wherein the semiconductor channel layer is comprises material comprising at least one of Silicon, Germanium, Gallium, Arsenic, Indium, Aluminium, Phosphor, and compounds thereof.

19. The method of claim 11, wherein the intermediate layer comprises a crystalline material.

20. The method of claim 11, wherein the intermediate layer is formed with a thickness between 10 nm and 400 nm.
